(19) United States
(12) Patent Application Publication
(10) Pub. No.: US 2010/0267355 A1
(43) Pub. Date: Oct. 21, 2010

(54) Method for allowing Reestablishment of A call to A mobile terminal that is blocked from receiving calls

(76) Inventor: Douglas W. Varney, Naperville, IL (US)

Correspondence Address: Alcatel-Lucent USA Inc.;Docket Administrator, Room 2F-192, 600-700 Mountain Ave., Murray Hill, NJ, 07974-0636, US

(21) Appl. No.: 12/386,422

(22) Filed: Apr. 17, 2009

(51) Int. Cl. H04M 11/04

(52) U.S. Cl. 455/404.1

(57) ABSTRACT

The present invention provides a method for establishing and reestablishing an emergency call to a mobile terminal that is currently not allowed to place normal calls. A mobile terminal that is currently not allowed to place normal calls sends an emergency call request. The communication system determines that the mobile terminal is subscribed to a flexible spending plan and allows the mobile terminal to place the emergency call after checking with a flexible spending limits application. If the emergency call ends improperly, the communication system reestablished the emergency call with the mobile terminal by overriding the prohibition on the mobile terminal receiving normal calls.

### FIELD OF THE INVENTION

The present invention relates generally to communication systems, and more particularly to emergency calls in communication systems.

### BACKGROUND OF THE INVENTION

Telecommunications users have occasion to make emergency calls. Mobile users may have a phone that does not have service or may be enrolled in a service plan that does not currently provide service, such as when the user has exceeded the spending limit or the service package is pre-paid and the user has exceeded the pre-paid number of minutes. In such situations, cellular systems may provide the ability for the cell phone to place an emergency call despite the fact that the phone may not be able to place other non-emergency calls.

There are times when an emergency call is disconnected prematurely or an emergency services operator has need to re-establish communication to gather additional information. In this instance, it is desirable for the call to be reestablished. The emergency operator can call back the phone that placed the emergency call. However, if the phone that placed the emergency call is not allowed to receive calls, the return call from the emergency dispatcher will not be received by the phone. This could lead to a dangerous situation for the caller who placed the original emergency call.

Therefore, a need exists for a method of allowing an emergency services function to be able to connect with a user who currently has incoming calls blocked.

### BRIEF SUMMARY OF THE INVENTION

An exemplary embodiment of the present invention provides a method for establishing and reestablishing an emergency call between a mobile terminal that is currently not allowed to receive calls and an emergency services provider.

In accordance with an exemplary embodiment, a mobile terminal that has a subscriber plan that currently does not allow it to receive phone calls, such as a subscriber that is over their spending limits or may subscribe to a prepaid plan that currently has a zero balance, sends a call establishment message. The call establishment message preferably includes an emergency indication.

The MSC receives the emergency message and determines from information within the emergency message that mobile terminal is subscribed to a flexible spending plan and therefore knows that a request for disposition of the emergency call request message needs to be send to a flexible spending limits application 201 to determine if this call should be allowed.

The MSC sends a message requesting call disposition to the flexible spending limits application. The message preferably includes information that the mobile terminal is attempting to place an emergency call.

The flexible spending limits application analyzes the message to determine if the mobile terminal is able to place this call. In accordance with an exemplary embodiment, since the call request is an emergency call, flexible spending limits apparatus allows the mobile terminal to complete the emergency call, in spite of the fact that the mobile terminal is currently prevented from placing normal calls. In accordance with an exemplary embodiment, the flexible spending limits application sets a flag associated with the mobile terminal and includes a time stamp to indicate the time that the emergency call was placed.

The flexible spending limits application sends an allow message to the MSC. In an exemplary embodiment, the allow message is a CAMEL message. The call request is then routed to an emergency services provider via an emergency call message. The emergency services operator processes the emergency call, for example by connecting the mobile terminal with an emergency dispatcher. At this point the emergency call is established between the mobile terminal and the emergency services operator.

At some point in this exemplary embodiment, the emergency call is either lost or torn down. The abnormal termination may occur for various reasons, such as the user of the mobile terminal accidentally hitting the “end call” button on the mobile terminal, a temporary bad connection, a bad cell, or any other scenario that ends the call without the user of the mobile terminal intending to end the emergency call. Further, there may be occasions when the emergency operator would like to contact the emergency caller after an emergency call has ended normally.

The MSC alerts the emergency services operator that the emergency call with the mobile terminal has been lost by sending an emergency call lost message to the emergency services operator. The emergency services operator knows that the emergency call was ended improperly. Further, there are circumstances when the emergency operator would like additional information from the caller, such as clarification of the caller's location, and so will, in accordance with an exemplary embodiment of the present invention, reestablish the emergency call with the mobile terminal.

The emergency services operator initiates a process to reestablish the emergency call with the mobile terminal by sending an initiate call message to the MSC. At this point, in the scenario where the mobile terminal does not have any limitations on receiving calls, the MSC would go through the steps of reestablishing the call with the mobile terminal.

In the exemplary embodiment where the mobile terminal is restricted from receiving incoming calls, the MSC determines that it should contact the flexible spending limits application to determine if the mobile terminal can receive the emergency call reestablishment message.

The MSC sends a request for disposition of the call request check message to the flexible spending limits application. In an exemplary embodiment, the call disposition request message is a CAMEL message.

The flexible spending limits application determines if the mobile unit is allowed to receive the emergency reestablishment call. Since in this exemplary embodiment the mobile terminal is currently unable to receive normal calls due to, for example, exceeded a spending limit or a particular calling plan, the mobile terminal would typically not be able to receive the call. However, in accordance with this exemplary embodiment, the flexible spending limits application checks to determine if the mobile terminal recently ended an emergency call improperly. For example, if the reestablish call is received from the emergency services operator within a predetermined time period from the time at which an emergency call was placed by the mobile terminal, the reestablishment call is allowed.

The flexible spending limits application sends an allow call message to the MSC. The allow call message is preferably a CAMEL message.

The MSC routes the callback emergency call to the mobile terminal by sending a call establishment message to the mobile terminal. This reestablishes the emergency call between the mobile terminal and the emergency services operator.

### BRIEF DESCRIPTION OF THE SEVERAL VIEWS OF THE DRAWINGS

FIG. 1 depicts a portion of a communication system in accordance with an exemplary embodiment of the present invention.

FIG. 2 depicts a flow diagram of a method for establishing and reestablishing an emergency call between a mobile terminal that is currently not allowed to receive calls and an emergency services provider in accordance with an exemplary embodiment of the present invention.

### DETAILED DESCRIPTION OF THE INVENTION

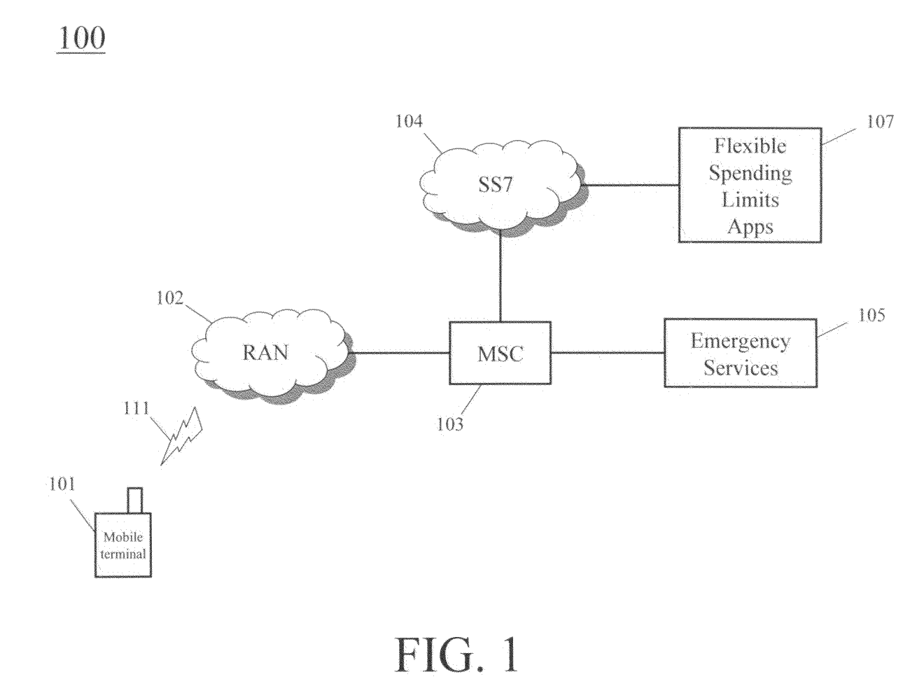

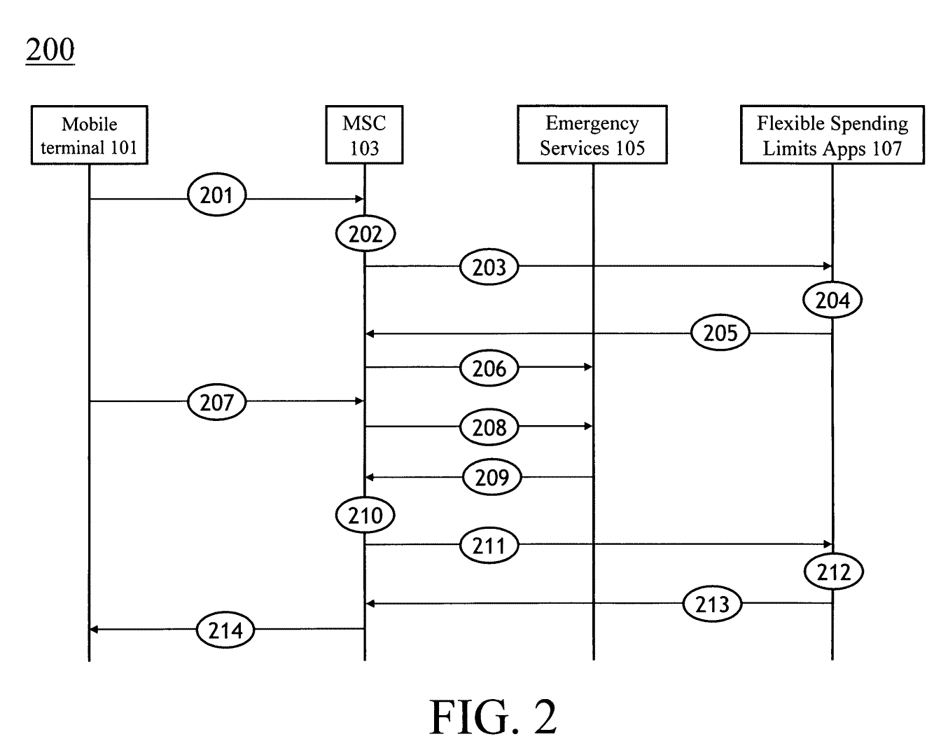

An exemplary embodiment of the present invention can be better understood with reference to FIGS. 1 and 2. FIG. 1 depicts a portion 100 of a communication system in accordance with an exemplary embodiment of the present invention. Portion 100 includes mobile terminal 101, RAN 102, MSC 103, SS7 104, Emergency services provider 105, and flexible spending limits application 307.

Mobile terminal 101 is a device supporting voice communication using a wireless air interface.

RAN 102 is a Radio Access Network and includes the antennae, base stations, and base station controllers that provide the wireless interconnection with mobile terminal 101 and other mobile terminals (not shown).

MSC 103 is a Mobile Switching Center. MSC 103 is the network element that provides voice services and enables mobile terminals to communicate to the Public Switched Telephone Network (PSTN). MSC (103) performs a Service Switching Function role as defined in ITU and other standards.

SS7 104 is the signaling network that supports communication between switches and between Service Switching Points and Service Control Points.

Emergency services provider 105 is an organization that provides public safety services, such as police, fire, and emergency medical services. Emergency services provider 105 is typically reachable from phones by calling a short number sequence, such as 911.

Flexible spending limits application 307 is an application typically within a telecom network that provides limits to amount of communication for a subscriber.

FIG. 2 depicts a flow diagram 200 of a method for establishing and reestablishing an emergency call between a mobile terminal that is currently not allowed to receive calls and an emergency services provider in accordance with an exemplary embodiment of the present invention.

In accordance with the exemplary embodiment depicted in FIG. 2, mobile terminal 101 is a mobile unit that has a subscriber plan that currently does not allow it to receive phone calls. For example, mobile terminal 101 may be a subscriber that is over their spending limits or may subscribe to a prepaid plan that currently has a zero balance.

Mobile terminal 101 sends a call establishment message 201 to MSC 103. Call establishment message 201 preferably includes an emergency indication. Emergency message 201 is preferably sent over the air as message 111 and traverses RAN 102. It should be understood that emergency message 201 can pass through multiple network elements prior to reaching MSC 103.

MSC 103 receives emergency message 201. MSC 103 determines (202) from information within emergency message 201 that mobile terminal 101 is subscribed to a flexible spending plan and therefore knows that a request for disposition of the emergency call request message 201 to determine if this call should be allowed.

MSC 103 sends a message 203 requesting call disposition to flexible spending limits application 107. Message 203 preferably includes information that mobile terminal 101 is attempting to place an emergency call. In an exemplary embodiment, the call disposition request message 203 is a CAMEL message. In further exemplary embodiments, message 203 can be a WIN message, a SIP message, or any other message format that supports communication between MSC 103 and flexible spending limits application 107.

Flexible spending limits application 107 analyzes message 203 to determine (204) if the calling phone, mobile terminal 101, is able to place this call. In accordance with an exemplary embodiment, since the call request is an emergency call, flexible spending limits apparatus 107 allows mobile terminal 101 to complete the emergency call, in spite of the fact that mobile terminal 101 is currently prevented from placing calls. In accordance with an exemplary embodiment, flexible spending limits application 107 sets a flag associated with mobile terminal 101 and includes a time stamp to indicate the time that the emergency call was placed.

Flexible spending limits application 107 sends allow message 205 to MSC 103. In an exemplary embodiment, allow message 205 is a CAMEL message. In further exemplary embodiments, allow message 205 can be a WIN message, a SIP message, or any other message format that supports communication between MSC 103 and flexible spending limits application 107.

The call request is then routed to emergency services 105 via emergency call message 206. Emergency services 105 processes the emergency call, for example by connecting mobile terminal 101 with an emergency dispatcher. At this point the emergency call is established between mobile terminal 101 and emergency services 105.

At some point in this exemplary embodiment, the emergency call is either lost or torn down (207). The abnormal termination may occur for various reasons, such as the user of mobile terminal 101 accidentally hitting the “end call” button on mobile terminal 101, a temporary bad connection, a bad cell, or any other scenario that ends the call without the user of mobile terminal 101 intending to end the emergency call. Further, there may be occasions when the emergency operator would like to contact the emergency caller after an emergency call has ended normally.

MSC 103 alerts emergency services 105 that the emergency call with mobile terminal 101 has been lost by sending emergency call lost message 208 to emergency services 105. Emergency services 105 knows that the emergency call was ended improperly. Further, there are circumstances when the emergency operator would like additional information from the caller, such as clarification of the caller's location, and so will, in accordance with an exemplary embodiment of the present invention, reestablish the emergency call with mobile terminal 101.

Emergency services 105 initiates a process to reestablish the emergency call with mobile terminal 101 by sending initiate call message 209 to MSC 103. At this point, in the scenario where mobile terminal 101 does not have any limitations on receiving calls, MSC 103 would go through the steps of reestablishing the call with mobile terminal 101.

In the exemplary embodiment depicted in FIG. 2, where mobile terminal 101 is restricted from receiving incoming calls, MSC 103 determines (210) that it should contact flexible spending limits application 107 to determine if mobile terminal 101 can receive the emergency call reestablishment message.

MSC 103 sends a request for disposition of the call request check message 211 to flexible spending limits application 107. In an exemplary embodiment, call disposition request message 211 is a CAMEL message. In further exemplary embodiments, message 211 is a WIN message, a SIP message, or any other message format that supports communication between MSC 103 and flexible spending limits application 107.

Flexible spending limits application 107 determines (212) if mobile unit 101 is allowed to receive the emergency reestablishment call. Since in this exemplary embodiment mobile terminal 101 is currently unable to receive calls due to, for example, exceeded a spending limit or a particular calling plan, mobile terminal 101 would typically not be able to receive the call. However, in accordance with this exemplary embodiment, flexible spending limits application 105 checks to determine if mobile terminal 101 recently ended an emergency call improperly. For example, if the reestablish call is received from emergency services 105 within a predetermined time period from the time at which an emergency call was placed by mobile terminal 101, the reestablishment call is allowed.

Flexible spending limits application 107 sends allow call message 213 to MSC 103. Allow call message 213 is preferably a CAMEL message, but can alternately be a WIN message, a SIP message, or any other message format that supports communication between MSC 103 and flexible spending limits application 107.

MSC 103 routes the callback emergency call to mobile terminal 101 by sending call establishment message 214 to mobile terminal 101. This reestablishes the emergency call between mobile terminal 101 and emergency services 105.

While this invention has been described in terms of certain examples thereof, it is not intended that it be limited to the above description, but rather only to the extent set forth in the claims that follow.

I claim:

1. A method for reestablishing an emergency call to a mobile terminal that is currently not allowed to receive calls, the method comprising:
determining that an emergency call has ended improperly;
determining that the mobile terminal is not currently allowed to receive normal calls; and
reestablishing the emergency call with the mobile terminal by overriding the prohibition on the mobile terminal receiving normal calls.

2. A method for reestablishing an emergency call to a mobile terminal that is currently not allowed to receive calls in accordance with claim 1, wherein the step of determining that the mobile terminal is not currently allowed to receive calls comprises determining that the mobile terminal currently subscribes to a service plan that does not allow the mobile terminal to receive calls.

3. A method for reestablishing an emergency call to a mobile terminal that is currently not allowed to receive calls in accordance with claim 2, wherein the step of determining that the mobile terminal currently subscribes to a service plan that does not allow the mobile terminal to receive calls comprises determining that the mobile terminal has exceeded predetermined spending limits.

4. A method for reestablishing an emergency call to a mobile terminal that is currently not allowed to receive calls in accordance with claim 2, wherein the step of determining that the mobile terminal currently subscribes to a service plan that does not allow the mobile terminal to receive calls comprises determining that the mobile terminal subscribes to a prepaid plan that currently has a zero balance.

5. A method for reestablishing an emergency call to a mobile terminal that is currently not allowed to receive calls in accordance with claim 1, wherein the step of determining that an emergency call has ended improperly comprises determining that an emergency operator would like to reestablish the emergency call with the mobile terminal.

6. A method for reestablishing an emergency call to a mobile terminal that is currently not allowed to receive calls in accordance with claim 1, wherein the step of determining that an emergency call has ended improperly comprises determining that the emergency operator would like additional information from the mobile terminal.

7. A method for reestablishing an emergency call to a mobile terminal that is currently not allowed to receive calls in accordance with claim 6, wherein the additional information comprises the location of the mobile terminal.

8. A method for reestablishing an emergency call to a mobile terminal that is currently not allowed to receive calls in accordance with claim 1, wherein the step of reestablishing the emergency call with the mobile terminal by overriding the prohibition on the mobile terminal receiving normal calls comprises determining if the mobile terminal has recently ended an emergency call.

9. A method for reestablishing an emergency call to a mobile terminal that is currently not allowed to receive calls in accordance with claim 8, wherein the step of determining if the mobile terminal has recently ended an emergency call comprises determining if the mobile terminal ended an emergency call within a predetermined time period.

10. A method for establishing an emergency call to a mobile terminal that is currently not allowed to place calls, the method comprising:
receiving an emergency call request from a mobile terminal that is currently not allowed to place normal calls;
determining that the mobile terminal is subscribed to a flexible spending plan; and
allowing the mobile terminal to place the emergency call.

11. A method for establishing an emergency call to a mobile terminal that is currently not allowed to place calls in accordance with claim 10, the method further comprising the step of determining that the emergency call has ended improperly.

12. A method for establishing an emergency call to a mobile terminal that is currently not allowed to place calls in accordance with claim 11, the method further comprising the step of reestablishing the emergency call with the mobile terminal.

13. A method for establishing an emergency call to a mobile terminal that is currently not allowed to place calls in accordance with claim 12, wherein the step of reestablishing the emergency call with the mobile terminal comprises determining if the mobile terminal has recently ended an emergency call.

14. A method for establishing an emergency call to a mobile terminal that is currently not allowed to place calls in accordance with claim 11, wherein the step of determining that an emergency call has ended improperly comprises determining that an emergency operator would like to reestablish the emergency call with the mobile terminal.

15. A method for establishing an emergency call to a mobile terminal that is currently not allowed to place calls in accordance with claim 11, wherein the step of determining that an emergency call has ended improperly comprises determining that the emergency operator would like additional information from the mobile terminal.

16. A method for establishing an emergency call to a mobile terminal that is currently not allowed to place calls in accordance with claim 15, wherein the additional information comprises the location of the mobile terminal.

17. A method for establishing an emergency call to a mobile terminal that is currently not allowed to place calls in accordance with claim 10, the method further comprising the step of indicating that the mobile terminal is allowed to place an emergency call.

18. A method for establishing an emergency call to a mobile terminal that is currently not allowed to place calls in accordance with claim 17, wherein the step of indicating that the mobile terminal is allowed to place an emergency call comprises setting a flag associated with the mobile terminal.

19. A method for establishing an emergency call to a mobile terminal that is currently not allowed to place calls in accordance with claim 17, wherein the step of indicating that the mobile terminal is allowed to place an emergency call comprises setting a time stamp associated with the mobile terminal.

20. A method for establishing an emergency call to a mobile terminal that is currently not allowed to place calls in accordance with claim 19, wherein the time stamp indicates the time that the emergency call was placed.
